(19) United States
(12) Patent Application Publication
(10) Pub. No.: US 2005/0083306 A1
(43) Pub. Date: Apr. 21, 2005

(54) Removable fingernail protectors for keys and pushbuttons

(76) Inventor: Chuck Monary, Mission Viejo, CA (US)

Correspondence Address: Michael J. Colitz, III;Holland & Knight LLP, 100 N. Tampa Street, Suite 4100, Tampa, FL, 33602-3644, US

(21) Appl. No.: 10/934,946

(22) Filed: Sep. 3, 2004

Related U.S. Application Data
(63) Continuation-in-part of application No. 10/301,507, filed on Nov. 21, 2002.
(60) Provisional application No. 60/332,416, filed on Nov. 21, 2001.

(51) Int. Cl. G09G 5/00; G10C 3/12

(52) U.S. Cl. 345/168

(57) ABSTRACT

Disclosed is a keyboard key cover formed from a polyurethane or a polyvinyl material. The key covers each include a pressure sensitive adhesive which allow the covers to be applied to the upper surfaces of a keyboard key. Preferably, the key covers are transparent to allow the user to view the indicia on the upper surface of the underlying keyboard key.

### RELATED APPLICATION DATA

This application claims priority from provisional application Ser. No. 60/332,416 filed on Nov. 21, 2001 entitled Removable Nail Guard Protector for Keyboard, and the utility application Ser. No. 10/301,507 filed on Nov. 21, 2002 entitled Removable Fingernail Protectors for Keys and Pads. The contents of both applications are incorporated herein by reference.

### BACKGROUND OF THE INVENTION

1. Field of the Invention

This invention relates to key covers for the keys of a keyboard. More particularly, the present invention relates to transparent key covers that are removably secured to a keyboard key via a low binding adhesive.

2. Description of the Background Art

The use of covers or extensions for the keys of a conventional keyboard is known in the art. For example, U.S. Pat. No. 4,755,072 to Hoornweg discloses a removable transparent, colored keycap for the color coding of a keyboard. Hoornweg allows colored caps to be used in distinguishing particular sub-sets on a keyboard, while at the same time maintaining proper key designations. The caps are form fitted and are secured to an individual key by way of friction and/or vacuum forces.

Furthermore, U.S. Pat. No. 5,201,594 to Adinolfi et al. discloses an extension for the keys of a keyboard. The extensions have a rigid extension rod with a soft rubbery top. These covers are adapted to be positioned upon the top of a business machine key. By way of the extension, conventional operation of a key is permitted even when the operator has elongated fingernails.

U.S. Pat. No. 5,290,115 to Little discloses a cushioning means for keyboard keys. The apparatus includes keypads which can be applied to key tops by way of a suitable adhesive. The keypads include a legend so that once the pads are applied to the key tops, they can still be read by an operator.

Although each of the above referenced inventions achieves its individual objective, they all share common problems. Namely, none of the background art discloses the use of a transparent key cover which provides a cushioning and protective benefit to a user, while at the same time permitting the user to observe any indicia located on the upper surface of the keyboard key.

### SUMMARY OF THE INVENTION

It is therefore one of the objectives of this invention to provide a transparent key cover which is adapted to be secured to the top of an individual key by way of a pressure sensitive adhesive.

It is also an object of this invention to provide a key cover that is formed from a light-weight and durable polyurethane or polyvinyl.

It is still another object of this invention to provide transparent key covers of varying shapes and sizes to accommodate the different shapes and sizes of a conventional computer keyboard.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a plan view of a conventional computer keyboard.

FIG. 2 is a partially exploded view of a conventional computer keyboard with the key covers of the present invention secured thereto.

FIG. 3 is a perspective view of a keyboard with key covers secured thereto.

FIG. 4 is a detailed view of an individual keyboard key with a key cover being secured thereto.

FIG. 5 is a detailed view of an individual keyboard key with a key cover secured thereto.

FIG. 6 is a perspective view of a packing arrangement for a plurality of key covers.

FIG. 7 is a plan view of an alternative packing arrangement for a plurality of key covers.

FIG. 8 is a perspective view of the key covers applied to the keys of an alarm system.

FIG. 9 is a perspective view of the key covers applied to the keys of a telephone.

FIG. 10 is a sectional view of the key board cover of the present invention.

FIG. 11 is a sectional view of the key board cover with the uppermost layer being removed.

Similar reference characters refer to similar parts throughout the several views of the drawings.

### DETAILED DESCRIPTION OF THE PREFERRED EMBODIMENT

The present invention relates to key covers for the keys of a keyboard or other device utilizing keys or pushbuttons. The key covers are formed from a transparent resilient thermoplastic material and are removably secured over a corresponding key by way of a low binding adhesive. The key covers function in preventing damage to a user's fingernails when their fingers impact the keys. The various components of the present invention are described in greater detail hereinafter.

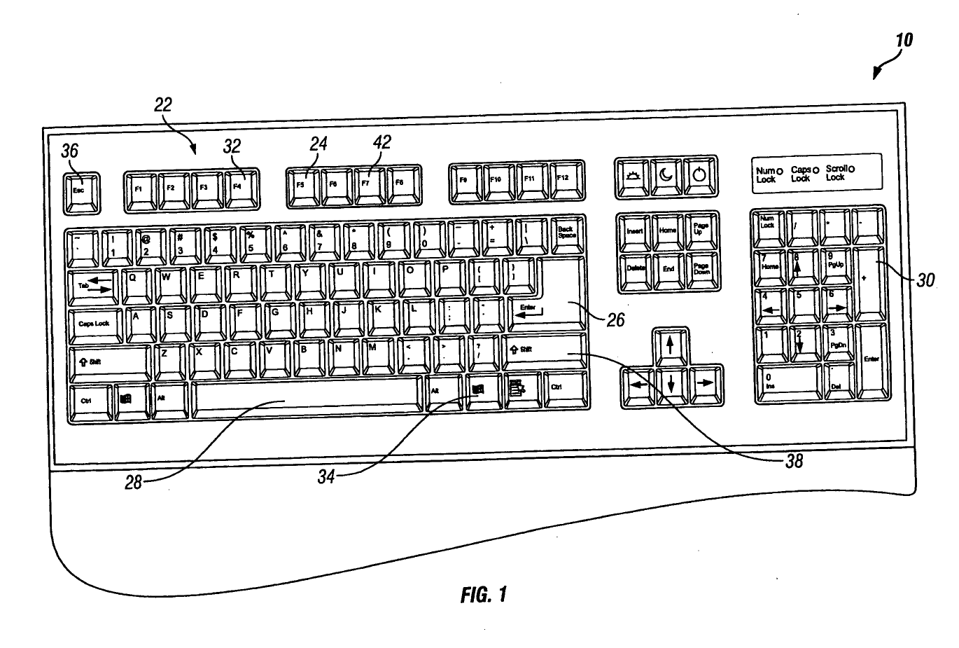

With reference now to FIG. 1, a conventional computer keyboard 10 is depicted. The key covers 20 of the present invention find particular application upon the keys 22 of such a keyboard. The keyboard 10 includes a number of individual square keys 24 for letters such as A through Z and numbers 0 to 9. Additional square keys 24 are included for such things as function keys F1 through F12. As is typical, the keyboard 10 includes keys of various shapes and sizes. For example, the enter key 26 depicted is in the shape of a reverse L, and the space key 28 is in the form of an elongated rectangle. Other key shapes and sizes can also be included within the keyboard 10.

Typically such keyboard keys are formed from a rigid plastic material so that they can withstand repeated impacts from the fingers of a user. Constructing the keys from a malleable or resilient material would subject the keys to premature wear and degradation. However, the hardened nature of the keys is undesirable from the standpoint of both user comfort and the damage that results to the fingertips of a user. This damage is particularly evident in users with elongated fingernails.

With continuing reference to FIG. 1, the various indicia 32 on the keyboard keys 22 is also depicted. Specifically, each key 22 has a letter, numeral, word, abbreviation or symbol on an upper surface. This indicia 32 allows an operator to see and understand which key they are about to depress. Without the ability to see the key indicia 32, the keyboard 10 is useless to the user. There are a wide variety of computer keyboards 10 on the market today each with a slightly different configuration with slightly different key indicia and/or key configurations. For example, keyboards manufactured by Microsoft® (or that are specifically for use with Microsoft® systems) may have one or more Windows logo keys 34. Additional logos may also be included that are unique to any given keyboard. Again, users need to have a clear view of these logos to properly utilize the keyboard 10.

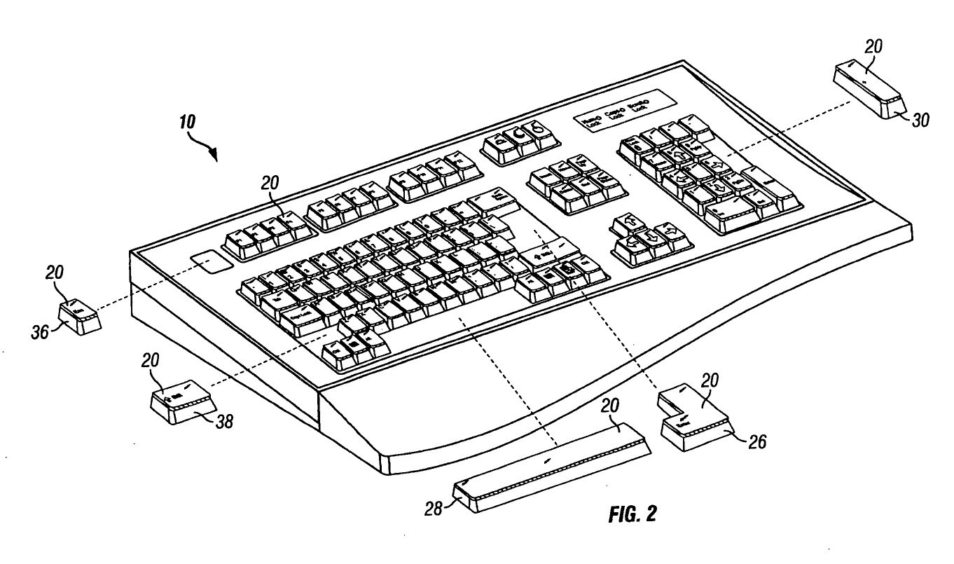

In accordance with the present invention, each of the keys 22 of the keyboard 10 is covered with a key cover 20. FIG. 2 is a partially exploded view showing the keyboard 10 of FIG. 1 with the individual key covers 20 applied thereto. Specifically, FIG. 2 shows exploded views of the escape 36, shift 38, space 28, enter 26 and addition key 30, each of which has a key cover 20 secured over its upper surface 42.

As can be appreciated, the transparent nature of the key cover 20 allows the indicia 32 on the upper surface 42 of the corresponding keyboard key 22 to be viewed by the user.

In the preferred embodiment, a plurality of key covers 20 are included such that every key 22 of the keyboard 10 can be covered. In this regard, the number, size and shape of the key covers 20 should correspond to the number, size and shape of the keyboard keys 22. For example, the key cover 20 for the space key 28 is formed into an elongated rectangle to conform to the upper surface 42 of the space key 28. Likewise, the key cover 20 for the enter key 26 is formed into a reverse L shape to match the upper surface 42 of the keyboard key 22. In the preferred embodiment, the peripheral edge of each key cover 20 is aligned with the upper peripheral edge of the corresponding key 22 upon which it is positioned. Thus, the covers do not hang over the edges of the keys 22.

In the preferred embodiment, each of the key covers 20 is formed from a resilient thermoplastic material. One suitable thermoplastic material is 3M Bumpon™ clear polyurethane roll stock (product numbers SJ-5632, SJ-5616, or SJ-5608). However, it is within the scope of the invention to construct the key covers 20 from other suitable materials. One such suitable material is a polyvinyl material. Whatever material is used, the essential characteristics are that the key cover 20 is resilient and transparent. The resilience functions in softening the impact of a user's finger upon the corresponding key. The transparent or see-through nature of the key cover allows a user to view any indicia 32 that may be on the upper surface 42 of the key being covered. Nonetheless, in one alternative embodiment, the key covers are formed from a colored semi-transparent material to give the cover a pleasing visual effect.

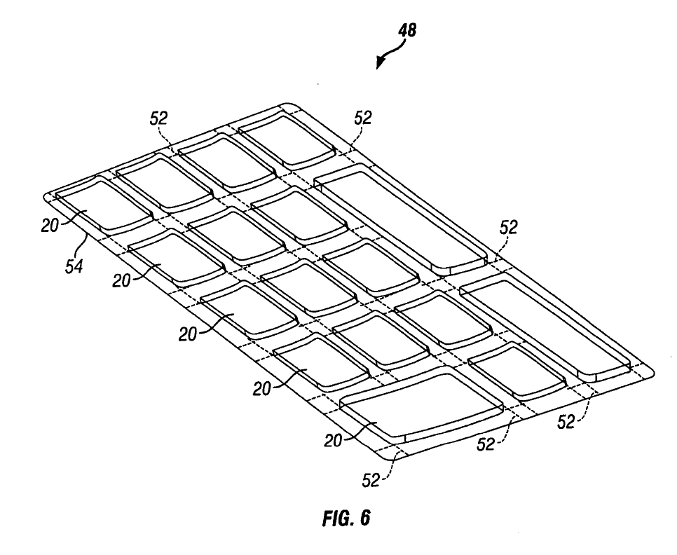

FIGS. 4 and 5 depict individual key covers 20 being secured to the upper surface 42 of a keyboard key 22. As illustrated, each key cover 20 has an upper surface, a lower surface and a thickness. In the preferred embodiment, the thickness of each key cover is less than 1/16 of an inch. It has been found that this thickness provides a sufficient degree of cushioning without adding undesirable height to the underlying key 22. Furthermore, on the lower surface of each key cover 20 a low binding adhesive 44 is secured. To ensure that the key cover 20 remains transparent the low binding adhesive 44 is preferably clear. A suitable adhesive is an A-20 acrylic adhesive. The low binding nature of the adhesive 44 ensures that once the key cover 20 is firmly secured over its corresponding key 22 it cannot be inadvertently removed. Yet, if a user wishes to remove an individual key cover 20 they may do so without too much difficulty. The low binding adhesive 44, thus, allows the key covers to be reused on various keyboards. In this regard the individual key covers 20 can include a backing sheet 46 to cover the adhesive 44 prior to the key cover 20 being applied to a key 22. As depicted in FIG. 4, the backing sheet 46 should be removed prior to applying the cover 20 to a key 22. The backing 46 facilitates handling of the cover 20 prior to its application.

With reference now to FIG. 6, one packaging configuration 48 for the key covers 20 is depicted. In this arrangement the plurality of key covers 20 are secured to one another in a matrix. The border 52 between adjacent key covers 20 is scored such that the border 52 is frangible. With this packing arrangement 48 one large backing sheet 46 with similar score lines is included on the lower surface of the key covers 20 to protect the adhesive 44. Thus, a user need only tear out one individual key cover 20 along the score line and thereafter remove the backing sheet 46. The cover 20 can then be applied to an individual keyboard key 22. Although the packing arrangement in FIG. 6 only depicts 17 covers 20, any number of key covers 20 can be included in the package 48. That is, the arrangement can have larger matrices.

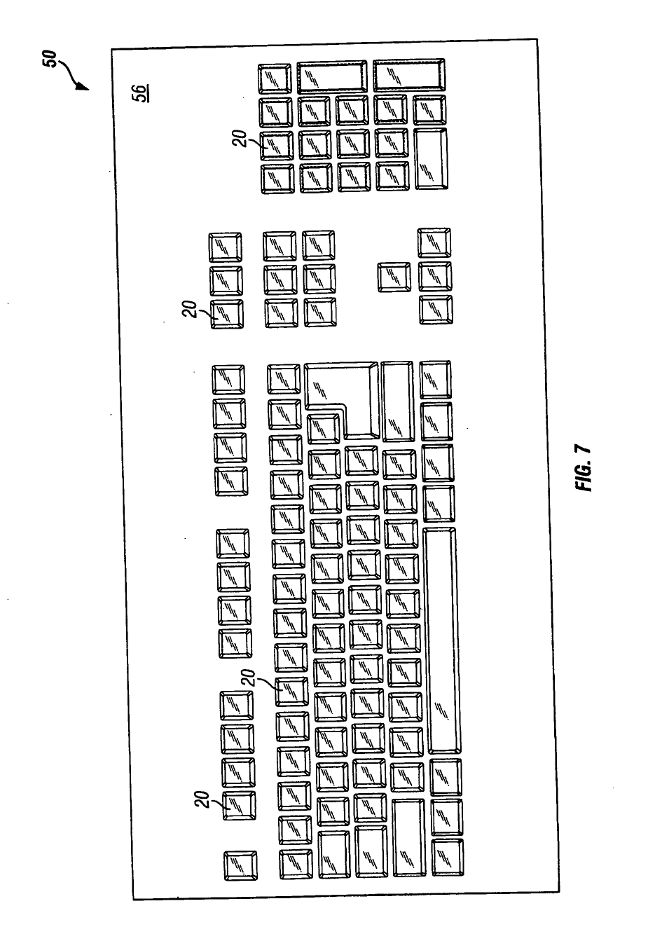

FIG. 7 shows yet another packing arrangement 50 of the present invention. In this arrangement the plurality of key covers 20 are stored upon a nonporous support layer 56. In this regard, the support layer 56 functions as the backing sheet. The nonporous nature gives the support layer 56 a slickness which allows individual key covers 20 to be easily removed. That is, each of the key covers 20 is secured upon the support layer 56 by way of the low binding adhesive 44. The nonporous support layer 56 enables the individual key covers 20 to be quickly removed without much effort.

In the packing arrangement of FIG. 7, the individual key covers 20 are arranged on the support layer 56 in the configuration of a computer keyboard. Thus, a user need only lift off the individual key covers 20 and apply them to the keyboard 10. In one further modification, the key covers 20 are arranged as depicted in FIG. 7, however, the covers 20 are spaced at one or more joints to allow the support layer 56 to be folded. This enables the support layer 56 to be easily placed within a package for display at a point of sale location.

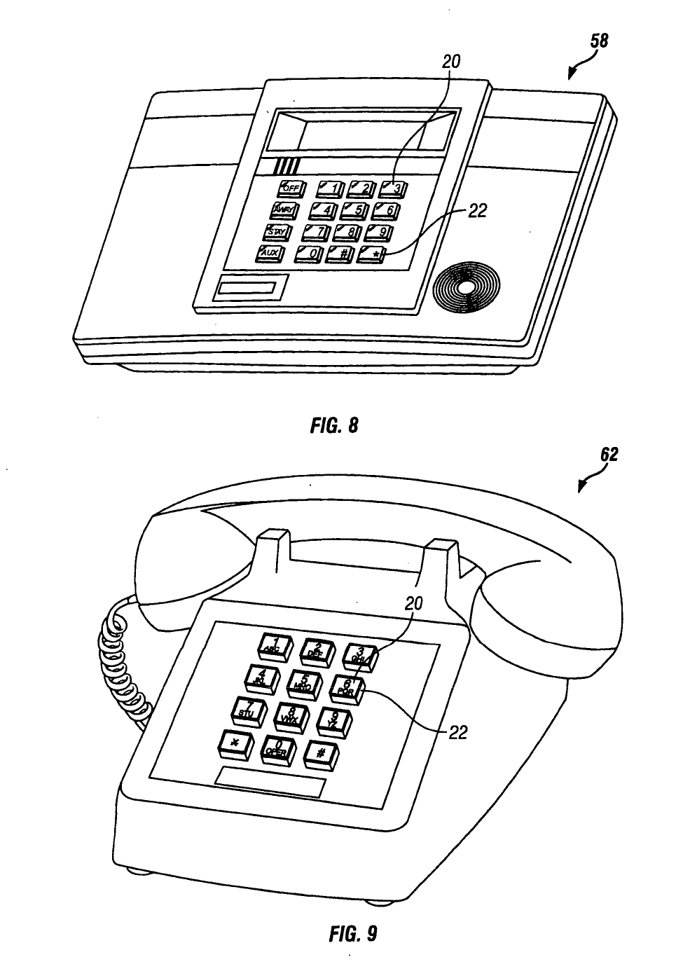

Although the present invention has been described as having particular application upon the keys 22 of a computer keyboard, it is within the scope of the present invention to use the key covers 20 upon the keys or pushbuttons of a variety of different devices. For example, FIG. 8 illustrates the key covers 20 in use upon the keys 22 of an alarm system 58. FIG. 9 illustrates the key covers 20 in use upon the keys of a pushbutton telephone 62. Thus, the present invention is not specific to any given keyboard configuration.

The method by which the key covers of the present invention are used is next described. Prior to applying the key covers, a user first cleans the keyboard keys with a cleaning solution. This ensures that any dust or unwanted materials are removed. Thereafter, the keys are permitted to dry. The individual key covers are then removed from their packaging configuration. This can be the block packaging arrangement depicted in FIG. 6 or the support layer packaging arrangement in FIG. 7. If it is the block packaging arrangement in FIG. 6, the keys covers must first be broken out and the backing layers removed. In the packaging arrangement of FIG. 7, the individual key covers need only be removed from the support layer. Thereafter, the individual key covers are applied to the tops of the keys. The covers are firmly pressed upon the keys to ensure a secure fit. Preferably, the device to which the keyboard is attached is turned off. The number and shape of the key covers should correspond to the number and shape of the keys being covered. Thus, key covers are matched to corresponding keys by size and shape. Thereafter, once all keys are covered the user can begin manual typing operations. The key covers provide a resilient cushioning effect to the user and otherwise protect the user's fingertips and fingernails from the adverse consequences of repeated impacts.

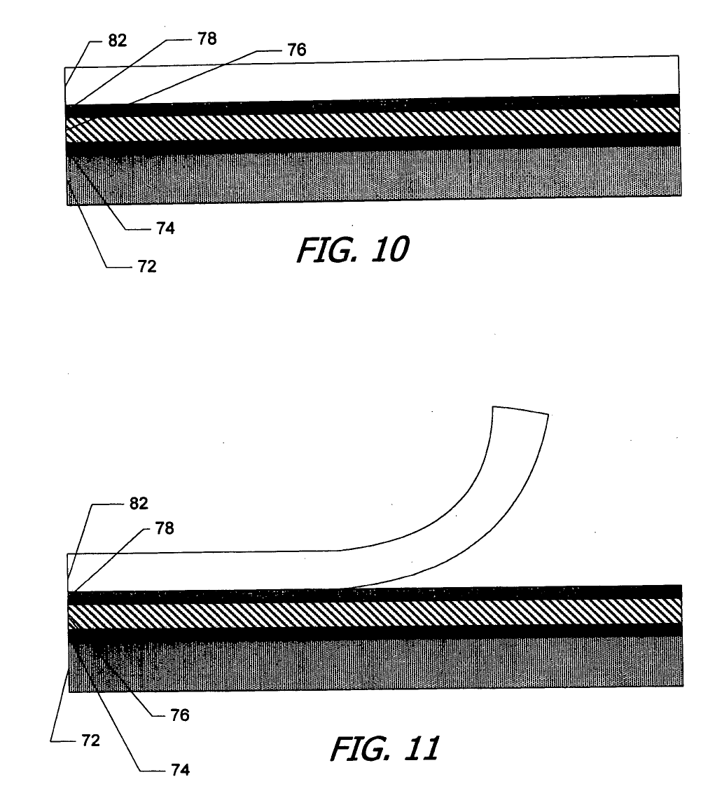

FIGS. 10 and 11 depict the preferred materials employed in the support layer packaging arrangement of FIG. 7. Specifically, as noted by the cross sectional views, the packaging arrangement utilizes a support layer 72, a first adhesive layer 74, a release liner 76, a second adhesive layer 78, and the key cover layer 82. Each of these layers is described in greater detail hereinafter.

Support layer 72 is formed from a sturdy card stock, with 24 point card stock being preferred, and is designed to provide a degree of rigidity to the supported key covers. Layer 72 preferably contains indicia that can be viewed through the transparent, supported key covers. For instance, support layer 72 may contain printing designating the individual keys of a computer keyboard, with the individual key covers being positioned over top of the corresponding keyboard key designation. Other printed matter can also be included on layer 72, such as logos and the name of the manufacturer.

A first adhesive layer 74 is then coated on top of support layer 72. This adhesive layer is designed to secure release liner 76 to the top of support layer 72. In the preferred embodiment the adhesive is a permanent pressure sensitive acrylic adhesive, such as the Flexmark V-29 adhesive made by FLEXcon Products of Spencer, Mass. This adhesive layer can either be applied separately or it can be included as the backing to the release liner 76.

Release liner 76 is preferably formed from a 1.0 mil thick silicone coating with an ultra smooth clear polyester. The preferred release liner is provided by FLEXcon products under the tradename Trackrite 100.

A second adhesive layer 78 is provided over the release liner. The preferred adhesive for the second layer is a 1.0 mil permanent pressure sensitive acrylic adhesive supported with a semi bleached kraft release liner, such as the Flexmount TT 100 v-344 55 LA K adhesive made by FLEXcon.

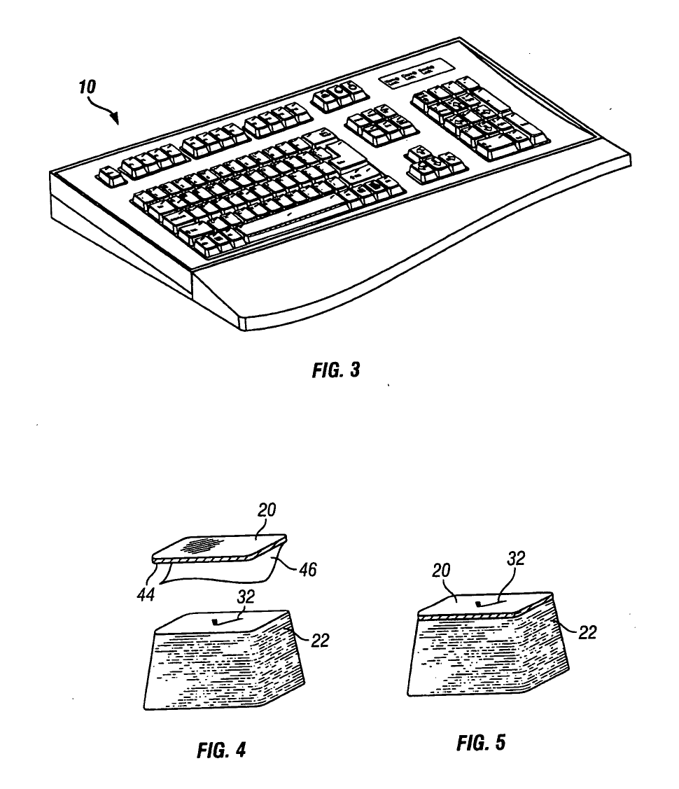

Finally, key cover layer 82 is releasably secured to release layer 76 via adhesive layer 78. It should be understood that, although reference number 82 depicts a layer, it is actually one of the individual key covers of the type discussed above and depicted in FIGS. 1-9. In the preferred embodiment, the key covers are formed from a flexible poly vinyl chloride (PVC) material. It has been discovered that adding a plasticizer to the PVC provides the desired degree of flexibility to the key covers.

However, some plasticizers leach into the adjacent adhesives and degrade them. This results in the unintended separation of the key covers from release layer 76. In order to overcome this drawback, the present inventor has discovered that the use of a polymeric plasticizer is preferred. That is, polymeric plasticizers do not leach into the surrounding adhesive and serve to preserve the integrity of the nearby adhesives. This is achieved without sacrificing the needed flexibility for the individual key board covers. FIG. 11 depicts key board over layer 82 being removed from release liner 76.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

1. A system for protecting the fingernails and nail polish of a keyboard user, the system comprising:
a keyboard having a number of keys in at least two different shapes, each of the keys being formed from a rigid material and having an upper surface bearing indicia thereon;
a number of key covers, each of the key covers having a shape and being substantially planar, the number and shape of the key covers corresponding to the number and shape of the keyboard keys, each of the key covers being formed from a resilient, transparent, thermoplastic material, each of the key covers having an upper surface, a lower surface, and a thickness, a low binding transparent adhesive secured to the lower surface of each of the key covers, each of the key covers being secured to the upper surface of one of the keyboard keys of a similar shape, each of the key covers and transparent adhesive permitting the user to view the indicia of the upper surface of each of the keyboard keys below, each of the key covers functioning to protect a user's fingernails upon impact with the keyboard keys.

2. A system for protecting the fingernails and nail polish of a keyboard user, the system comprising:
a keyboard having a plurality of keys, each of the keys having an upper surface with indicia thereon;
a plurality of key covers each formed from a resilient, transparent, thermoplastic material, each of the key covers having upper and lower surfaces, a low binding transparent adhesive secured to the lower surface of each of the key covers, each of the key covers being secured to the upper surface of one of the keys of the keyboard, the transparency of each of the key covers permitting the user to view the indicia upon the upper surface of each of the keys of the keyboard below, each of the key covers functioning to protect a user's fingernails upon impact with the keyboard keys.

3. The system as described in claim 2 wherein the keyboard keys have at least two different shapes and wherein the key covers are shaped to conform to the keyboard keys.

4. The system as described in claim 2 wherein the adhesive is a low binding adhesive that allows the key covers to be removed from the keyboard keys.

5. A system for protecting the fingernails and nail polish of a keyboard user, the system comprising:
a keyboard having a plurality of keys, each of the keys having an upper surface with indicia thereon;
a plurality of key covers each formed from a resilient, transparent, polyvinyl chloride that is softened with a polymeric plasticizer, each of the key covers having upper and lower surfaces, a low binding transparent adhesive secured to the lower surface of each of the key covers, each of the key covers being secured to the upper surface of one of the keys of the keyboard, the transparency of each of the key covers permitting the user to view the indicia upon the upper surface of each of the keys of the keyboard below, each of the key covers functioning to protect a user's fingernails upon impact with the keyboard keys.

6. The system as described in claim 5 wherein the plurality of key covers are initially adhesively secured to a silicon release liner.

7. The system as described in claim 5 wherein the polymeric plasticizer is selected so as to avoid degradation of the low binding transparent adhesive.
